(19) United States
(12) Patent Application Publication
(10) Pub. No.: US 2008/0101992 A1
(43) Pub. Date: May 1, 2008

(54) Microchip and Microchip Inspection System

(75) Inventors: Akihisa Nakajima, Tokyo (JP); Kusunoki Higashino, Osaka (JP); Yasuhiro Sando, Hyogo (JP); Youichi Aoki, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 11/923,234

(22) Filed: Oct. 24, 2007

(30) Foreign Application Priority Data
Oct. 27, 2006 (JP) JP2006-292359

(51) Int. Cl. B01J 19/00

(52) U.S. Cl. 422/68.1

(57) ABSTRACT

An objective is to provide a microchip exhibiting no scattering of stored reagent together with reduced size, which is capable of rapidly mixing the reagent when used. Also disclosed is a microchip possessing a reaction section in which reaction with a reagent or a specimen supplied from a flow path is conducted via heat, wherein the reaction section possesses a storage section to store the reagent in advance, and the reagent previously stored in the storage section is sealed with a material which generates phase transition from a solid phase to a liquid phase between a storage temperature and a reaction temperature.

This application claims priority from Japanese Patent Application No. 2006-292359 filed on Oct. 27, 2006, which is incorporated hereinto by reference.

### TECHNICAL FIELD

The present invention relates to a microchip and a microchip inspection system.

### BACKGROUND

In recent years, attention has been focused on a system used for specimen preparation, chemical analysis and chemical synthesis via a micro-machine technology and a micro-processing technology, in which devices and means (for example, pumps, valves, flow paths, sensors and the like) are micronized and integrated on a single chip. This is also called μ-TAS (Micro Total Analysis System), and is a method in which a reagent solution and a specimen solution (an extracted solution in which, for example, urine, saliva, blood and a test specimen are treated to conduct a DNA treatment) are incorporated into a member called a microchip, and characteristics of the test specimen are inspected by detecting the reaction.

As to microchips, disclosed have been various processes such as a photolithography process in which grooves are produced by etching patterned images with chemicals, a method in which fine flow paths to flow the reagent solution and a specimen solution, and reagent storage sections after the groove processing employing laser light to mold what has been produced via the processing, and so forth are provided

Further, concerning this μ-TAS, much is expected of their application in the fields of medical testing and diagnosis, environmental measurement and agricultural manufacturing. As seen in gene testing in particular, in the case where complicated steps, skilful operations, and machinery operations are necessary, a microanalysis system which is automatic, speedy and simple is very beneficial not only in terms of cost, required amount of sample and required time, but also in terms of achieving analyses, regardless of time and place.

In various analyses and tests, quantitation of analysis, accuracy of analysis and economic factors with such the microchips are largely taken into account. Therefore, it is desired to produce microchips exhibiting high accuracy and excellent reliability, together with a simple structure. The inventors of the present invention have already disclosed a suitable micro pump system and a control method thereof (Patent Documents 1-4).

(Patent Document 1) Japanese Patent O.P.I. Publication No. 2004-28589

(Patent Document 2) Japanese Patent O.P.I. Publication No. 2001-322099

(Patent Document 3) Japanese Patent O.P.I. Publication No. 2004-108285

(Patent Document 4) Japanese Patent O.P.I. Publication No. 2004-270537

### SUMMARY

As to the analysis with the above-described μ-TAS, in order to conduct rapid analysis and inspection, it is desired that reagent is previously sealed in flow paths formed on a microchip. However, when a large amount of reagent is used for the analysis, a large number of flow paths receiving the reagent are desired to be provided on the microchip. As the result, the microchip becomes large in size.

In the case of previously sealing the reagent in a microchip, it is desired to prevent scattering of the reagent during storage prior to use, and to prevent leaking of the reagent from storage sections storing the reagent to the flow path connected to the storage sections during storage prior to use. The reagent should be rapidly mixed when used, and it is further desired to be able to smoothly flow out the reagent from the storage sections storing the reagent to a successive flow path.

It is an object of the present invention to provide a microchip exhibiting no scattering of stored reagent together with reduced size, which is capable of rapidly mixing the reagent when used.

### BRIEF DESCRIPTION OF THE DRAWINGS

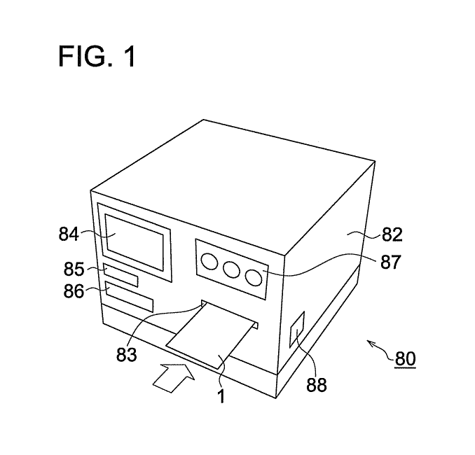

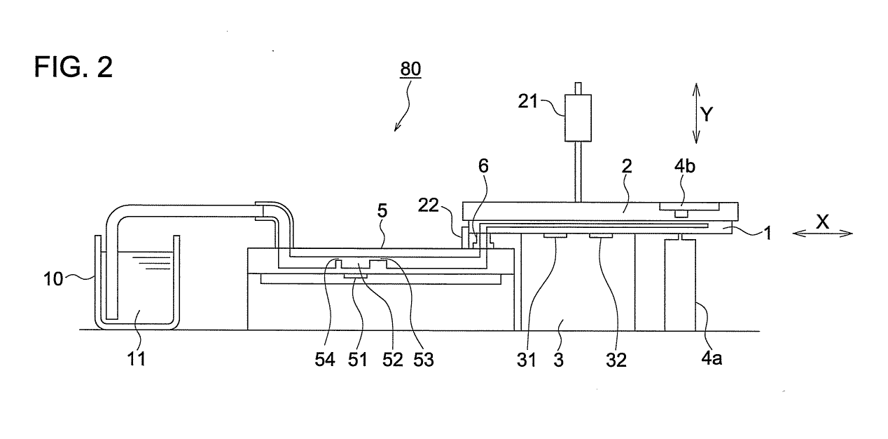

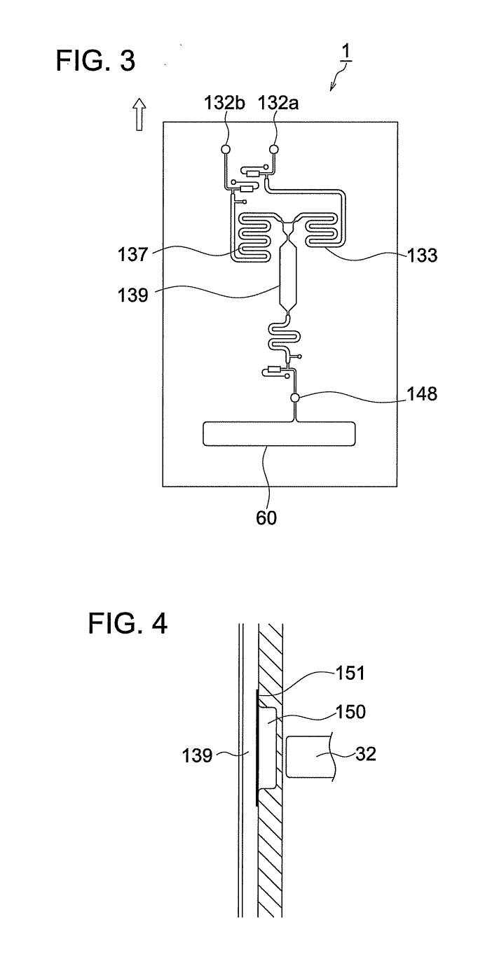

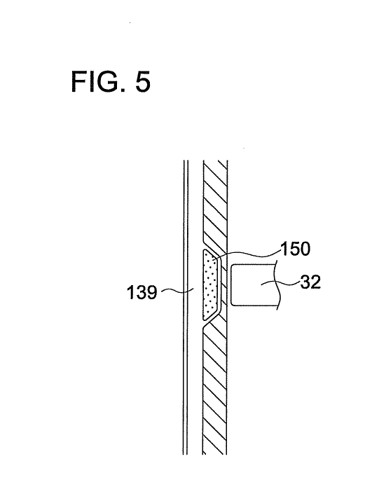

Embodiments will now be described, by way of example only, with reference to the accompanying drawings which are meant to be exemplary, not limiting, and wherein like elements numbered alike in several figures, in which: FIG. 1 is an external view of an inspection apparatus fitted with a microchip of the present embodiment; FIG. 2 is a schematic diagram of an inspection apparatus fitted with a microchip of the present embodiment; FIG. 3 is a schematic diagram of a microchip of the present embodiment; FIG. 4 is a lateral cross-sectional view of a microchip of the first embodiment; and FIG. 5 is a lateral cross-sectional view of a microchip of the second embodiment.

### DESCRIPTION OF THE PREFERRED EMBODIMENTS

The above object of the present invention is accomplished by the following structures.

(Structure 1) A microchip comprising a reaction section in which reaction with a reagent or a specimen supplied from a flow path is conducted via heat, wherein the reaction section comprises a storage section to store the reagent in advance, and the reagent previously stored in the storage section is sealed with a material which generates phase transition from a solid phase to a liquid phase between a storage temperature and a reaction temperature.

(Structure 2) The microchip of Structure 1, wherein the material is paraffin.

(Structure 3) A microchip comprising a reaction section in which reaction with a reagent or a specimen supplied from a flow path is conducted via heat, wherein the reaction section comprises a storage section to store the reagent in advance, and the reagent previously stored in the storage section comprises a material which generates phase transition from a solid phase to a liquid phase between a storage temperature and a reaction temperature.

(Structure 4) The microchip of Structure 3, wherein the material is gelatin or agarose.

(Structure 5) The microchip of any one of Structures 1 -4, wherein the storage section comprises a depression in a part of the reaction section.

(Structure 6) A microchip inspection system comprising a microchip inspection apparatus comprising the microchip of any one of Structures 1-5, a microchip storage section to store the microchip, a heating section to heat the reaction section of the microchip during storing the microchip in the microchip storage section.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

Embodiments of the present invention will now be described. In addition, the present invention will be explained referring to the embodiments shown in figures, but the present invention is not limited thereto. The following description in the embodiments of the present invention indicates the best mode, but significance of terms and technological scope in the present invention are not limited.

Next, the embodiments of the present invention will be described referring to figures. (Apparatus configuration) FIG. 1 is an external view of inspection apparatus 80 fitted with a microchip of the present embodiment. Inspection apparatus 80 is an apparatus of automatically outputting reaction results obtained by automatically reacting the reagent and the test specimen previously injected in microchip 1.

Enclosure 82 of inspection apparatus 80 is fitted with insertion slot 83 to insert microchip 1 into the apparatus, display section 84, memory card slot 85, print output slot 86, operation panel 87 and external input-output terminal 88.

A person in charge of inspection inserts microchip 1 in the direction of an arrow shown in FIG. 1, and operates operation panel 87 to start inspection. Inspection of reaction inside microchip 1 is automatically conducted in the interior of inspection apparatus 80, and results are displayed at display section 84 after terminating inspection. Via operation of operation panel 87, not only prints are output from print output slot 86, but also inspection results can be recorded in a memory card inserted into memory card slot 85. Data can also be stored in a personal computer and the like employing, for example, a LAN cable connected from external input-output terminal 88. After terminating inspection, a person in charge of inspection removes microchip 1 from insertion slot 83.

FIG. 2 is a schematic diagram of an inspection apparatus fitted with a microchip of the present embodiment. In FIG. 2, a microchip is inserted from insertion slot 83 shown in FIG. 1, and is in the situation where setting is completed.

Inspection apparatus 80 is fitted with driving liquid tank 10 to store driving liquid 11 for transporting the reagent and test sample previously injected into microchip 1; micropump 5 to supply driving liquid 11 into microchip 1; pump connecting section 6 to connect micropump 5 to microchip 1 so as to leak driving liquid 11; temperature adjusting unit 3 to temperature-control a necessary section of microchip 1; chip pressure plate 2 to attach microchip 1 to temperature adjusting unit 3 and pump connecting section 6 so as not to misalign microchip 1; pressure plate driving section 21 to move chip pressure plate 2 up and down; regulation member 22 to position microchip 1 accurately with respect to micropump 5; light detecting section to detect a reactive state between the reagent and the test sample inside microchip 1; and so forth.

Chip pressure plate 2 an the initial stage is located above the position indicated in FIG. 2. In this case, microchip 1 is removable in the X direction of an arrow, and is inserted from insertion slot 83 by a person in charge of inspection until touching regulation member 22. After this, chip pressure plate 2 is let down by pressure plate driving section 21 to touch microchip 1, and the lower surface of microchip 1 is closely attached to temperature adjusting unit 3 and pump connecting section 6.

Temperature adjusting unit 3 is equipped with peltiert element 31 and heater 32 provided on the plane facing microchip 1, and peltiert element 31 and heater 32 are arranged to closely attach microchip 1 when microchip 1 is set in inspection apparatus 80. A section in which the reagent is stored is cooled with peltiert element 31 in such a way that the reagent does not get denatured, and a section in which the test specimen and the reagent are reacted is heated with heater 32 placed in a heating section so as to accelerate the reaction.

The light detecting section is composed of light emitting section 4a and light receiving section 4b, and microchip 1 is exposed to light coming from light emitting section 4a to detect light transmitting microchip 1 with light receiving section 4b. Light receiving section 4b is installed inside chip pressure plate 2 as an integrated unit. Light emitting section 4a and light receiving section 4b are placed so as to face detected section 148 (FIG. 3) of microchip 1.

Micropump 5 is fitted with pump room 52, piezoelectric element 51 by which a volume of pump room 52 is varied, first throttle flow path 53 located on the side of microchip 1 of pump room 52, second throttle flow path 54 located on the side of driving liquid tank 10 of the pump room, and so forth. First throttle flow path 53 and second throttle flow path 54 each are designed to be a throttled narrow flow path, and first throttle flow path 53 is also designed to be longer than second throttle flow path 54.

In the case of feeding driving liquid 11 in the forward direction (in the direction heading for microchip 1), piezoelectric element 51 is driven so as to rapidly reduce a volume of pump room 52. By doing so, turbulence is generated in second throttle flow path 54 as a short throttle flow path, whereby flow path resistance in second throttle flow path 54 becomes relatively larger than that in first throttle flow path 53 as a long throttle flow path. By this, driving liquid 11 inside pump room 52 is dominantly ejected in the direction of first throttle flow path 53 to feed the liquid. Next, piezoelectric element 51 is driven so as to slowly increase a volume of pump room 52. By doing so, driving liquid 11 flows in from first throttle flow path 53 and second throttle flow path 54 along with increase of the volume inside pump room 52. In this case, since second throttle flow path 54 is shorter in length than first throttle flow path 53, flow path resistance of second throttle flow path 54 becomes smaller than that of first throttle flow path 53, whereby driving liquid 11 flows dominantly into pump room 52 from second throttle flow path 54. The above-described operations are repeated with piezoelectric element 51 to feed driving liquid 11 in the forward direction.

In the case of feeding driving liquid 11 in the opposite direction (in the direction heading for driving liquid tank 10), piezoelectric element 51 is driven so as to slowly reduce a volume of pump room 52. By doing so, flow path resistance of second throttle flow path 54 becomes smaller than that of first throttle flow path 53 since second throttle flow path 54 is shorter in length than first throttle flow path 53. By this, driving liquid 11 inside pump room 52 is dominantly ejected in the direction of second throttle flow path 54 to feed the liquid. Next, piezoelectric element 51 is driven so as to rapidly increase a volume of pump room 52. By doing so, driving liquid 11 flows in from first throttle flow path 53 and second throttle flow path 54 along with increase of the volume inside pump room 52. In this case, turbulence is generated in second throttle flow path 54 as a short throttle flow path, and flow path resistance in second throttle flow path 54 becomes relatively larger than that in first throttle flow path 53 as a long throttle flow path, whereby driving liquid 11 flows dominantly into pump room 52 from first throttle flow path 53. The above-described operations are repeated with piezoelectric element 51 to feed driving liquid 11 in the opposite direction.

In order to prevent leakage of the driving liquid by securing enough sealing, it is preferable that a tight contact surface is formed from a resin having flexibility (elasticity and a shape-following property) such as polytetrafluoroethylene or silicon resin for pump connecting section 6. The tight contact surface having such the flexibility, for example, may be formed from a substrate itself constituting the microchip, and may also be formed from other flexible members attached around a flow path opening of pump connecting section 6.

### Structure of Microchip

FIG. 3 is a structure showing an example of microchip 1 in the present embodiment, but the present invention is not limited thereto.

In microchip 1, placed are a flow path and a flow path element to mix and react a fluid reagent and a fluid specimen (test specimen) on microchip 1. An example of a treatment applied to the inside of microchip 1 employing these flow path and flow path element will be described. Further, microchip 1 is composed of a grooved substrate and a covering substrate to cover the grooved substrate, but the arrangement of the flow path and the flow path element in the situation where the covering substrate is removed in FIG. 3 is schematically shown. In addition, an arrow in FIG. 3 indicates the direction of inserting microchip 1 into inspection apparatus 80.

Numerals 133 and 137 indicate a reagent reception section and a specimen reception section, respectively. Openings 132a and 132b that open outside from one surface of microchip 1 are provided on the upstream side of each reception section. When these openings 132a and 132b are connected by superimposing microchip 1 onto micropump 5 via pump connecting section 6, they are communicated with micropump 5 via position adjustment with a flow path opening provided on the connection surface of micropump 5.

Reaction section 139 to mix and react a reagent from reagent reception section 133 and a specimen from specimen reception section 137 is provided on the downstream side of reagent reception section 133 and specimen reception section 137.

Detected section 148 is provided on the downstream side of reaction section 139, and waste liquid section 60 is provided on the further downstream side,

A reagent stored in reagent reception section 133 flows into reaction section 139 with a driving liquid fed from micropump 5 communicated with opening 132a. On the other hand, a specimen stored in specimen reception section 137 flows into reaction section 139 with a driving liquid fed from separately arranged micropump 5 communicated with opening 132b. In this case, the reagent fed from reagent reception section 133 and the specimen fed from specimen reception section 137 are mixed in reaction section 139.

The reagent and the specimen which have been mixed in reaction section 139 are heated by heater 32 installed in inspection apparatus 80 to start reaction. The liquid after the reaction is fed into detected section 148. Intended substances are detected via, for example, an optical detection method and so forth in detected section 148. The liquid which has been detected in detected section 148 is fed into waste liquid section 60.

### Structure of the Present Invention

In cases when reaction is conducted by mixing the reagent and the specimen which flowed together in reaction section 139, together with another reagent, flow paths to feed the reagents run short. Here, the first embodiment will be explained referring to FIG. 4. FIG. 4 is a lateral cross-sectional view of reaction section 139. Storage section 150 is formed by producing depression in the part of reaction section 139, and the other reagent is designed to be stored in the depression. The reagent stored in storage section 150 is designed to be sealed with sheet-like material 151 in which phase transition from a solid phase to a liquid phase occurs between the storage temperature and the reaction temperature.

Sheet-like material 151 in which phase transition occurs is paraffin having a melting point of 20-60° C. and is also aliphatic hydrocarbon. Examples thereof include tetradecane, pentadecane, hexadecane, heptadecane, octadecane, nonadecane, eicosane, wax, paraffin wax and so forth. The material may be a film formed from a compound like gelatin in which a sol-gel transition occurs around 40° C.

The state where a polymer is present in a solution in the form of colloid is called “sol”. The state where a polymer forms a hydrogen bond in an aqueous solution is called “gel”, and the gel is formed via Brownian motion defeated by the hydrogen bond. As such the polymers exhibiting sol-gel phase transition, gelatin and natural polysaccharide such as agarose and the like are known, and the phase transition is generated from sol in a liquid state to gel in a soft solid state by cooling after dissolving the foregoing material in high temperature water. This phase transition temperature depends on kinds of materials, and gelatin having a sol-gel phase transition temperature of approximately 40° C., low molecular weight agarose having a sol-gel phase transition temperature of approximately 55° C. and so forth are preferably usable when storing a reactive reagent. A high molecular weight agarose having a sol-gel phase transition temperature of approximately 80° C. is also usable when starting reaction at high temperature applied for Hot Start PCR and the like. When the reagent gelates, gelation can be conducted by mixing the reagent and sol, but it is also possible that sol is previously charged in a storage section, the reagent is charged after gelation, and the reagent is dispersed in the gel to complete gelation. In the case of the latter, it is preferable in view of storage stability that the reagent is not exposed to high temperature during adjustment of the reagent.

Next, the second embodiment will be explained referring to FIG. 5. FIG. 5 is a lateral cross-sectional view of reaction section 139 showing a storage situation in which a reagent is stored in storage section 150 in the form of gel, after charging gelatin dissolved at 50° C. into the storage section to add the reagent after gelation. In this case, After the reagent subjected to gelation and reacted liquid are filled in the reaction section, the reaction section is heated to 40° C. and more to complete solation of gel, and they are to be mixed and reacted. In the case of the PCR reaction, temperature can be set to 98° C. at once to start reaction.

In addition to the second embodiment, for the third embodiment, sealing may be carried out with sheet-like material 151 (not shown in the figure).

Microchips in the first, second and third embodiments of the present invention were prepared, and inspected whether or not the reagent and the specimen were reacted at a heating temperature of 55° C. in the reaction section after inserting each of the microchips into inspection apparatus 80. As the result, it was confirmed that each of them was normally functioning with no problem.

### EFFECT OF THE INVENTION

In the present invention, a downsized microchip can be produced since the reaction section is used as a storage section of reagent. No reagent is also scattered during storage, and the reagent can be mixed rapidly when used, since the reagent at the reaction section can be fixed in the storage section during storage, and the fixed reagent can be easily released when used.

What is claimed is:

1. A microchip comprising a reaction section in which reaction with a reagent or a specimen supplied from a flow path is conducted via heat,
wherein the reaction section comprises a storage section to store the reagent in advance, and
the reagent previously stored in the storage section is sealed with a material which generates phase transition from a solid phase to a liquid phase between a storage temperature and a reaction temperature.

2. The microchip of claim 1,
wherein the material is paraffin.

3. A microchip comprising a reaction section in which reaction with a reagent or a specimen supplied from a flow path is conducted via heat,
wherein the reaction section comprises a storage section to store the reagent in advance, and
the reagent previously stored in the storage section comprises a material which generates phase transition from a solid phase to a liquid phase between a storage temperature and a reaction temperature.

4. The microchip of claim 3,
wherein the material is gelatin or agarose.

5. The microchip of claim 1,
wherein the storage section comprises a depression in a part of the reaction section.

6. A microchip inspection system comprising a microchip inspection apparatus comprising the microchip of claim 1, a microchip storage section to store the microchip, a heating section to heat the reaction section of the microchip during storing the microchip in the microchip storage section.
